(19) United States
(12) Patent Application Publication
(10) Pub. No.: US 2020/0065676 A1
(43) Pub. Date: Feb. 27, 2020

(54) NEURAL NETWORK METHOD, SYSTEM, AND COMPUTER PROGRAM PRODUCT WITH INFERENCE-TIME BITWIDTH FLEXIBILITY

(71) Applicant: National Tsing Hua University, Hsinchu City (TW)

(72) Inventors: Yun-Chen LO, Hsinchu City (TW); Yu-Shun HSIAO, Hsinchu City (TW); Ren-Shuo LIU, Hsinchu City (TW)

(73) Assignee: National Tsing Hua University, Hsinchu City (TW)

(21) Appl. No.: 16/545,181

(22) Filed: Aug. 20, 2019

Related U.S. Application Data
(60) Provisional application No. 62/721,003, filed on Aug. 22, 2018.

(51) Int. Cl. G06N 3/08; G06N 3/063; G06N 20/00; G06F 9/50

(52) U.S. Cl. CPC G06N 3/084; G06F 9/5027; G06N 20/00; G06N 3/063

(57) ABSTRACT

A method of training an N-bit neural network (N≥2), is proposed to include: providing the N-bit neural network that includes a plurality of weights to be trained, each of the weights being composed of N bits that respectively correspond to N bit orders which are divided into multiple bit order groups, wherein the bits of the weights are divided, based on the bit orders to which the bits of the weights correspond, into multiple bit groups that respectively correspond to the bit order groups; and determining the weights for the N-bit neural network by training the bit groups one by one.

### CROSS-REFERENCE TO RELATED APPLICATION

This application claims priority of U.S. Provisional Patent Application No. 62/721,003, filed on Aug. 22, 2018.

### FIELD

The disclosure relates to a neural network, and more particularly to a neural network method, system, and computer program product with inference-time bitwidth flexibility.

### BACKGROUND

Convolutional neural networks (CNNs) recently emerge as a promising and successful technique to tackle important artificial intelligence (AI) problems such as computer vision. For example, state-of-the-art CNNs can recognize a thousand categories of objects in the ImageNet dataset not only faster but also more accurate than humans.

CNNs are compute-intensive. As an example, AlexNet includes five convolutional layers, and each layer involves 100 million to 450 million multiplications. Therefore, the computing cost for recognizing a small 224×224-pixel image, which can involve more than one billion multiplications, is high enough, let alone the computing cost for processing large images or videos.

Low-bitwidth CNNs and accelerators rely on simplified multiplications, and are typically restricted to utilizing one- to four-bit, fixed-point weight values and activation values instead of full-precision values. For instance, multiplications of 1-bit CNNs are equivalent to logic XNOR operations, which are much simpler and consume much lower power than full-precision integer or floating-point multiplications.

Referring to FIG. 1, a 1-bit CNN and a 3-bit CNN were trained separately in an experiment, and not surprisingly, a 3-bit accelerator executing the 3-bit CNN (a bar corresponding to 3) achieved higher accuracy than a 1-bit accelerator executing the 1-bit CNN (a bar corresponding to 1) at inference time. This gain in accuracy comes at higher computing cost because a 3-bit multiplication is roughly nine times more complex than a 1-bit multiplication. However, when the 1-bit accelerator executed the 3-bit CNN (e.g., in a manner of rounding off or omitting the least significant bits (LSBs) of weights (weight values) and activations (activation values)), the accuracy became much worse than the 1-bit accelerator executing the 1-bit CNN, and was at an unacceptable level (a bar corresponding to 3→1).

In addition, the weights of CNNs may include both positive and negative integer numbers, so the conventional two's complement number system is used to represent the weights. However, the weight distributions of CNNs may be symmetric in relation to zero, but the two's complement number system does not provide a symmetric range with respect to zero, which may adversely affect the accuracy of the CNNs.

### SUMMARY

Therefore, one object of the disclosure is to provide a method of training an N-bit neural network, where N is a positive integer and N≥2, so that the trained N-bit neural network can achieve high accuracy when executed with a reduced bitwidth.

According to this disclosure, the method includes: providing the N-bit neural network that includes a plurality of weights to be trained, each of the weights being composed of N bits that respectively correspond to N bit orders divided into multiple bit order groups, wherein the bits of the weights are divided, based on the bit orders to which the bits of the weights correspond, into multiple bit groups that respectively correspond to the bit order groups; and determining the weights for the N-bit neural network by training the bit groups one by one. It should be noted that in this and the following disclosures, in practice, the N-bit neural network may include some additional weights other than the plurality of weights, and the additional weights may be of different bitwidth(s) from N-bit.

One object of the disclosure is to provide a computer program product which, when executed, establishes a neural network operable with different bitwidths while having relatively good accuracy.

According to this disclosure, the computer program product includes a neural network code that is stored on a computer readable storage medium, and, when executed by a neural network accelerator, that establishes a neural network having a plurality of sets of batch normalization parameters and a plurality of weights. The neural network is switchable among a plurality of bitwidth modes that respectively correspond to different bitwidths. The sets of the batch normalization parameters respectively correspond to the different bitwidths. In each of the bitwidth modes, each of the weights has one of the bitwidths that corresponds to the bitwidth mode. When executed by the neural network accelerator, the neural network operates in one of the bitwidth modes that corresponds to a bitwidth of the neural network accelerator, and one of the sets of the batch normalization parameters that corresponds to the bitwidth of the neural network accelerator is used by the neural network accelerator.

One object of the disclosure is to provide a computerized neural network system that is operable with different bitwidths at relatively good accuracy.

According to this disclosure, the computerized neural network system includes a storage module storing the computer program product of this disclosure, and a neural network accelerator coupled to the storage module and configured to execute the neural network code of the computer program product.

One object of the disclosure is to provide a computerized system that uses a binary number system providing a symmetric range with respective to zero.

According to the disclosure, the computerized system includes a plurality of multipliers, and a plurality of adders coupled to the multipliers, the multipliers and the adders cooperatively to perform computation. For each of data pieces that includes multiple bits respectively corresponding to multiple bit orders and that is used in computation of the adders and the multipliers, the bit order of i represents 2ⁱ when having a first bit value, and represents −2ⁱ when having a second bit value, where N is a number of bits of the data piece, i is an integer, and (N−1)≥i≥0.

One object of the disclosure is to provide a computerized neural network system that has complexity-accuracy flexibility.

According to this disclosure, the computerized neural network system includes a storage module storing a neural network, and a neural network accelerator coupled to said storage module. The neural network has a plurality of weights each composed of a respective number of bits, and the weights have a first number of bits in total. The neural network accelerator is configured to execute the neural network by, for each of the weights, using a part of the respective number of bits to perform computation, such that a total amount of bits of said weights that are used in the computation is smaller than the first number.

One object of the disclosure is to provide a computerized neural network system that can achieve a required accuracy while minimizing unnecessary power consumption.

According to this disclosure, the computerized neural network system includes a storage module storing a neural network, and a neural network accelerator coupled to said storage module. The neural network has a plurality of weights, and is switchable among a plurality of bitwidth modes respectively corresponding to different bitwidths for the weights. The neural network accelerator is configured to cause, based on an accuracy requirement for said neural network, said neural network to probabilistically operate between at least two of the bitwidth modes, and to execute the neural network that probabilistically operates between at least two of the bitwidth modes.

### BRIEF DESCRIPTION OF THE DRAWINGS

Other features and advantages of the disclosure will become apparent in the following detailed description of the embodiment (s) with reference to the accompanying drawings, of which:

FIG. 1 is a graph illustrating a drop in accuracy when a conventional 3-bit CNN is executed by a 1-bit accelerator;

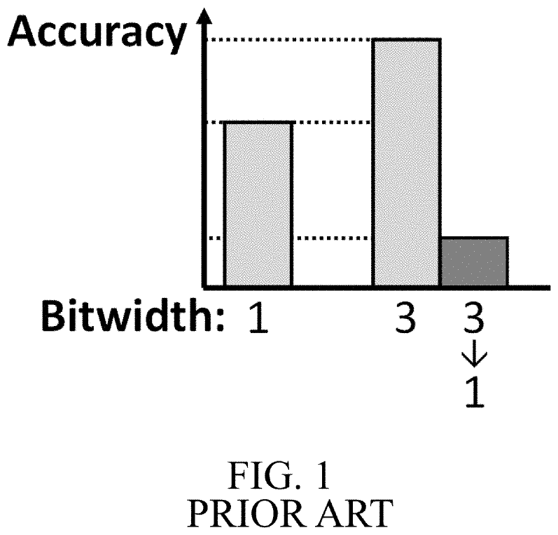

FIG. 2 is a schematic diagram illustrating a common computation process of a convolutional neural network;

FIG. 3 is a schematic diagram illustrating steps of training a 3-bit CNN using a bit-progressive training method of this disclosure;

FIG. 4 is a schematic diagram illustrating comparison of ranges that can be represented by a conventional two's complement number system and a bipolar number system of this disclosure;

FIG. 5 is a schematic diagram illustrating multiplications in the bipolar number system;

FIG. 6 is a plot illustrating a benefit of the bipolar number system;

FIG. 7 is a schematic diagram illustrating an exemplary circuit (or computation graph) for training a 3-bit CNN by the bit-progressive training method;

FIG. 8 is a block diagram illustrating an embodiment of a computerized neural network system according to this disclosure;

FIG. 9 is a graph illustrating a benefit of the disclosure in terms of top-5 accuracy;

FIG. 10 is a plot illustrating an energy-accuracy tradeoff line achieved by a 3-bit neural network trained according to this disclosure;

FIG. 11 is a schematic diagram illustrating use of different bitwidths for different layers; and

FIG. 12 is a schematic diagram illustrating use of different bitwidths for different channels of the same layer.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

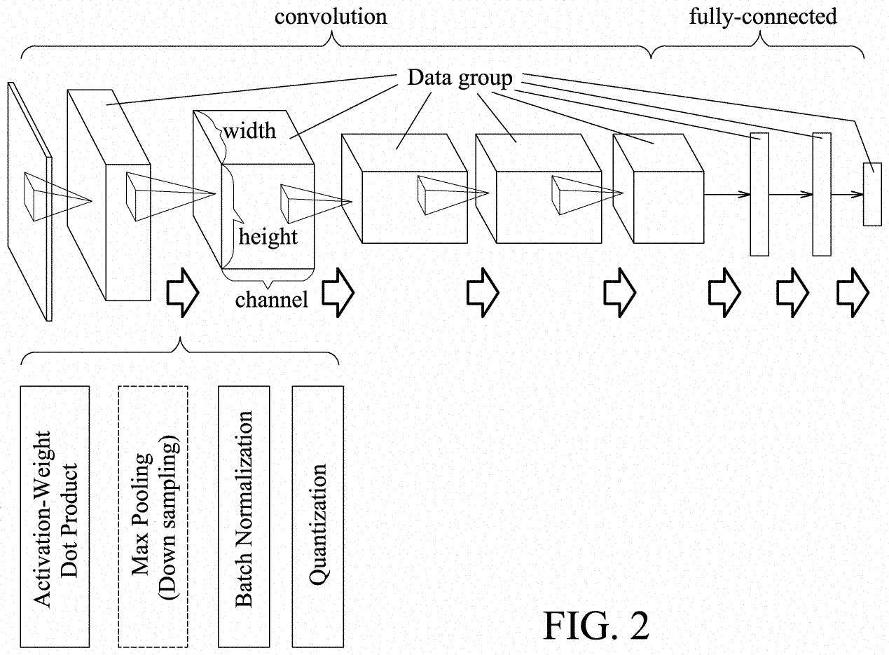

FIG. 2 illustrates a common computation process of a convolutional neural network (CNN), which includes multiple convolutional layers and optionally one or more fully-connected (FC) layers that are connected one by one. Each of the convolutional layers and the FC layers outputs a data group that serves as input data (i.e., activations) for the next layer, and data of an image is exemplified as input data of the CNN (i.e., activations of the first layer of the CNN). Each of the convolutional layers and the fully-connected layers has at least one channel that has a plurality of weights. For each layer in FIG. 2, a thickness of the layer represents a number of channel(s). Each channel is a group of dot products (also called inner products) of the activations and a specific set of weights. As an example, a layer that has 64 channels includes 64 sets of weights to perform convolution with the activations. Each of the convolutional layers and the fully-connected layers is configured to compute dot products of the activations and the weights of the layer, to optionally perform max pooling (down sampling) on the dot products, to perform batch normalization on the dot products or the dot products after the max pooling, and to perform quantization on the output of the batch normalization, thereby obtaining the corresponding data group that serves as the activations for the next layer.

This disclosure introduces a bit-progressive training method for training an N-bit neural network, where N is a positive integer and N≥2, such that the trained neural network has bitwidth flexibility at inference time. The bit-progressive training method may be implemented by one or more computers, but this disclosure is not limited in this respect.

The N-bit neural network includes a plurality of weights to be trained, and each of the weights is composed of N bits that respectively correspond to N bit orders (or bit positions) of 0 to N−1. The bit-progressive training method proposes to divide the N bit orders into multiple bit order groups. The bits of the weights are divided, based on the bit orders of the bits in the corresponding weights, into multiple bit groups that respectively correspond to the bit order groups, where each of the bit groups has a representative bit order which is a highest one of the bit order(s) in the corresponding one of the bit order groups. Then, the bit groups are trained one by one. In one embodiment, each of the bit groups is trained under the condition that, of each of the bit group(s) that has already been trained through a previous training, each of the bit(s) is fixed at a corresponding value that was determined for the bit through the previous training. In one embodiment, the order of succession of training the bit groups may be arranged from a most significant one of the bit groups to a least significant one of the bit groups, wherein the most significant one of the bit groups is one of the bit groups that has a highest one of representative bit orders among the bit groups, and the least significant one of the bit groups is one of the bit groups that has a lowest one of the representative bit orders among the bit groups.

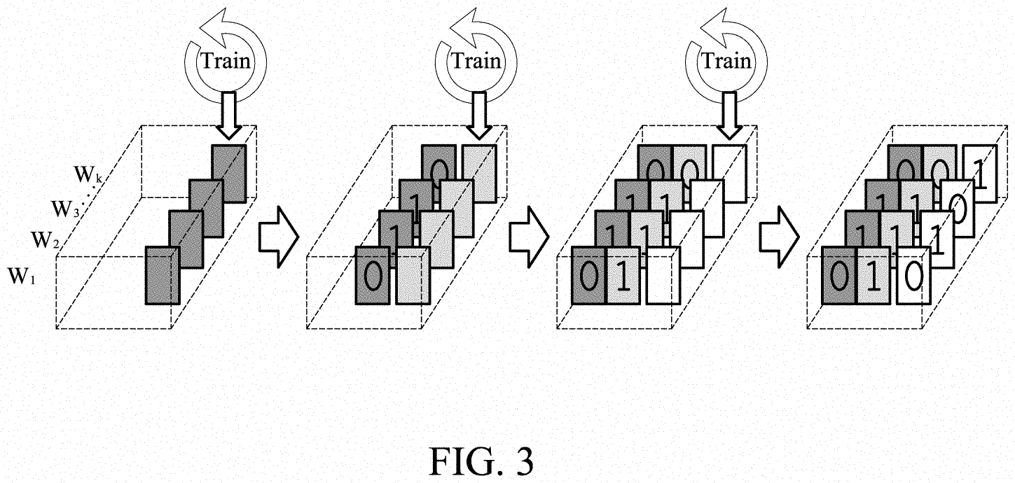

In FIG. 3, the N-bit neural network is exemplified as a 3-bit CNN, wherein each of the weights w₁-wₖ of the 3-bit CNN is composed of three bits. In this embodiment, the bits of the weights w₁-wₖ are divided into first to third bit groups respectively corresponding to bit orders of 2, 1 and 0 (three bit order groups, each containing one specific bit order). In the proposed bit-progressive training method, the first bit group that corresponds to the bit order of 2 (the highest bit order in this example) is trained first, in the manner of training a 1-bit CNN. Then, the second bit group that corresponds to the bit order of 1 is trained with each of the bits of the first bit group being fixed at a corresponding value that was determined through the training of the first bit group, as if training a 2-bit CNN in a case that only the bits that correspond to the least significant bit can be adjusted during training. Lastly, the third bit group that corresponds to the bit order of 0 is trained with each of the bits of the first and second bit groups being fixed at a corresponding value that was determined through the training of the first and second bit groups, like training a 3-bit CNN in a case that only the bits that correspond to the least significant bit can be adjusted during training. It is noted that this disclosure is not limited to training the bit groups in an order of succession from the highest bit order to the lowest bit order, although such arrangement may achieve a better accuracy for the trained CNN at inference time.

The N-bit neural network that is trained using the bit-progressive training method is thus switchable among a plurality of bitwidth modes that respectively correspond to different bitwidths. As an example, the 3-bit CNN trained in FIG. 3 is switchable among three bitwidth modes that respectively correspond to the bitwidths of one (where the bits with bit order of 2 are used), two (where the bits with bit orders of 2 and 1 are used), and three (where the bits with bit orders of 2, 1 and 0 are used), where in each of the bitwidth modes, each of the weights has one of the bitwidths that corresponds to the bitwidth mode (however, in practice, it would be possible that only some of the weights have the bitwidth corresponding to the bitwidth mode although this may be less effective). In order to optimize inference-time accuracies for the trained CNN in different bitwidth modes, for the training of each of the bit groups, a set of batch normalization parameters that is dedicated to an entirety of the bit group and each of the bit group (s) that has been trained before this bit group is being trained is determined. In other words, the set of batch normalization parameters corresponds to the bit group and all previously trained bit group(s) as a whole. Taking the 3-bit CNN in FIG. 3 as an example, for the training of the first bit group, a first set of batch normalization parameters that correspond to the first bit group (i.e., corresponding to the bitwidth of one) is determined along with the first bit group. For the training of the second bit group, a second set of batch normalization parameters that is dedicated to an entirety of the second bit group and the trained first bit group (i.e., corresponding to the bitwidth of two) is determined along with the second bit group. For the training of the third bit group, a third set of batch normalization parameters that is dedicated to an entirety of the third bit group and the trained first and second bit groups (i.e., corresponding to the bitwidth of three) is determined along with the third bit group. Accordingly, multiple sets of batch normalization parameters are prepared for the different bitwidth modes, respectively.

In FIG. 3, each bit order group corresponds to only one bit order, but this disclosure is not limited in this respect. In one example where the N-bit neural network is a 4-bit CNN, the four bit orders may be divided into three bit order groups that respectively correspond to the bit order of 3, the bit order of 2, and the bit orders of 1 and 0, and the bits in the bit group that corresponds to the bit orders of 1 and 0 are trained together with the bits that correspond to the bit orders of 2 and 3 being fixed in value; and correspondingly, three sets of batch normalization parameters may be prepared respectively for three bitwidth modes that respectively correspond to the bitwidths of 1 (bit), 2 (bits) and 4 (bits). In one example where the N-bit neural network is an 8-bit CNN, the eight bit orders may be divided into four bit order groups that respectively correspond to the bit order of 7, the bit order of 6, the bit orders of 5 and 4, and the bit orders of 3, 2, 1 and 0, where the bits of the bit group that corresponds to the bit orders of 5 and 4 are trained together with the bits that correspond to the bit orders of 7 and 6 being fixed in value, and the bits of the bit group that corresponds to the bit orders of 3 to 0 are trained together with the bits that correspond to the bit orders of 7 to 4 being fixed in value; and correspondingly, four sets of batch normalization parameters may be prepared respectively for four bitwidth modes that respectively correspond to the bitwidths of 1, 2, 4 and 8. In the above examples, for each of the bit order groups that has at least two bit orders, the at least two bit orders are consecutive (e.g., the bit orders of 1 and 0, the bit orders of 5 and 4, or the bit orders of 3, 2, 1 and 0), but this disclosure is not limited in this respect.

It is noted that a novel binary number system, which is called a bipolar number system hereinafter, may be applied to this disclosure in order to enhance bitwidth flexibility of the neural network. In the bipolar number system, for each data piece that includes multiple bits respectively corresponding to multiple bit orders, a bit that corresponds a bit order of i represents 2ⁱ in decimal when having a first bit value (e.g., a bipolar 1), and represents −2ⁱ when having a second bit value (e.g., a bipolar 0), where i is an integer. For example, “010” in the bipolar number system may represent a value of (−2²+2¹−2⁰)=(−4+2−1)=(−3) in decimal.

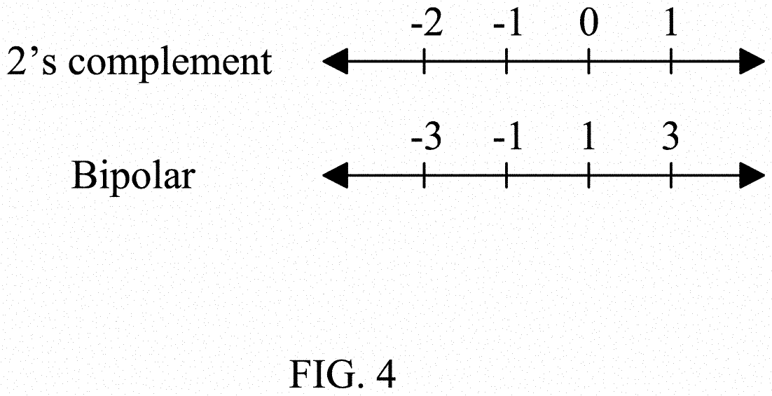

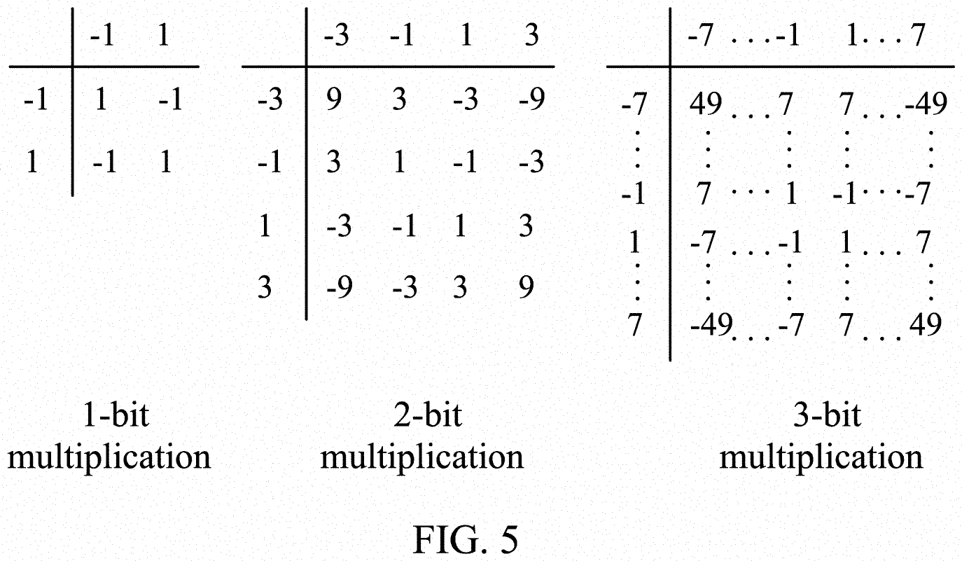

FIG. 4 shows a comparison between decimal number representations in the two's complement number system and in the bipolar number system, where the bipolar number system has asymmetric range with respect to zero, thereby enhancing the bitwidth flexibility for the neural network because the weight distributions of neural networks may be symmetric in relation to zero. FIG. 5 shows the products of two bipolar numbers. The products of two 1-bit bipolar numbers are 1 and −1 in decimal, the products of two 2-bit bipolar numbers spread between 9 and −9 in decimal, and so on. It is noted that the use of the bipolar number system is not limited to neural networks, but may be applied to any other computerized systems as desired.

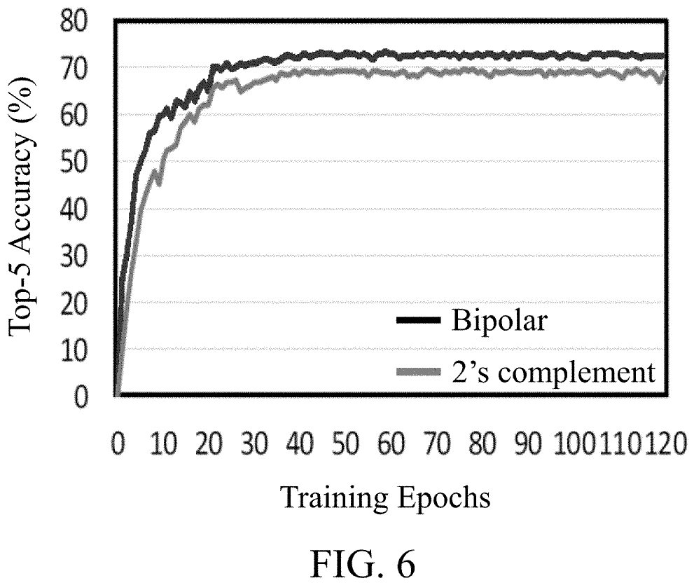

FIG. 6 compares the top-5 accuracy (the percentage that results (or guesses) of top 5 probabilities include the correct class) of training 2-bit CNNs using the bipolar number system and the two's complement number system to help visualize the benefits of the bipolar number system. It can be seen that using the bipolar number system consistently outperforms using two's complement number system by 4% in accuracy.

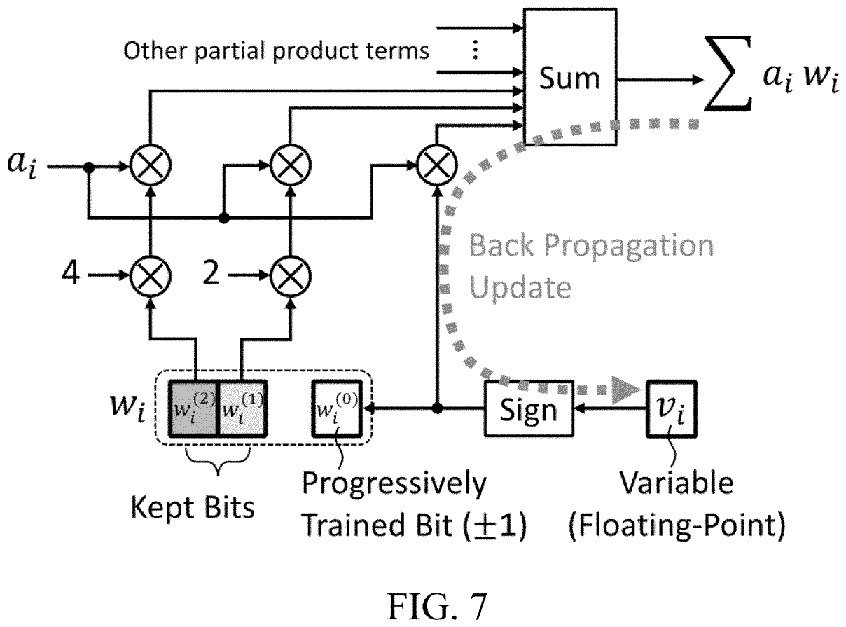

FIG. 7 shows an exemplary circuit (or computation graph) for training a 3-bit weight wᵢ of a CNN by the bit-progressive training method, where aᵢ represents a 3-bit activation corresponding to the weight wᵢ. In the depicted figure, the training for the most significant two bits that correspond to the bit orders of 2 and 1 has been completed, and thus the most significant two bits are fixed during the training of the least significant bit (LSB) that corresponds to the bit order of 0, which is referred to as a target bit that is currently being progressively trained. The exemplary circuit includes a plurality of multipliers and a plurality of adders to perform desired computations (e.g., dot products of the activations and the weights in this embodiment). The value of the target bit is determined based on a sign of a floating-point variable (e.g., being a bipolar “1” when the floating-point variable is a positive number, and being a bipolar “0” when the floating-point variable is a negative number). The value of the floating-point variable is adjusted by back propagation during the training. Since algorithms for back propagation should be familiar to one having ordinary skill in the art, details thereof are omitted herein for the sake of brevity. In practice, it is possible that some of computations are performed under the bipolar number system, and some of computations are performed under the two's complement number system.

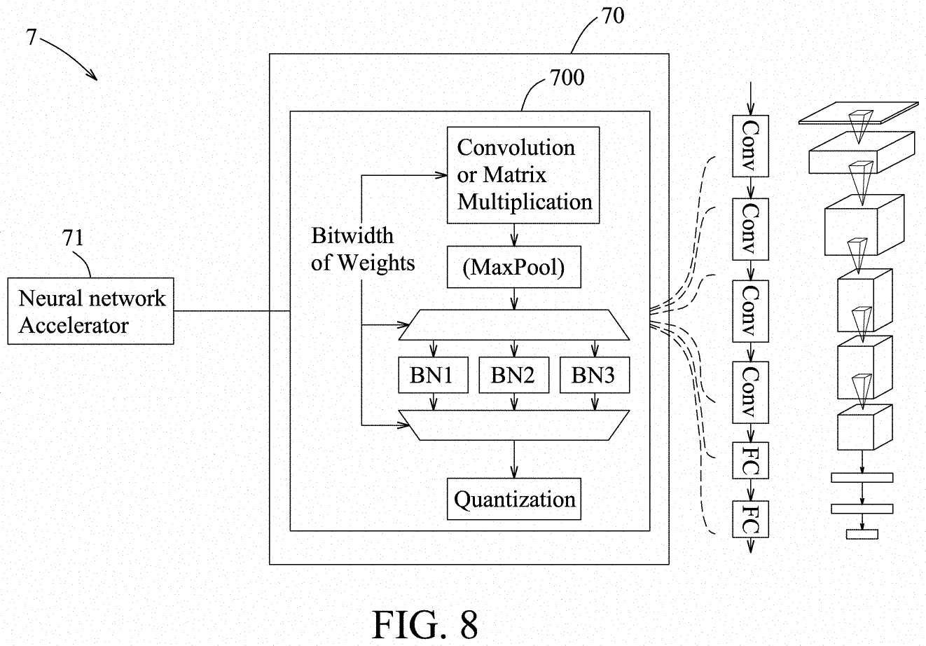

Referring to FIG. 8, an embodiment of a computerized neural network system 7 according to this disclosure is shown to include an M-bit neural network accelerator 71, and a storage module 70 (a computer readable storage medium, such as flip flops, DRAM, SRAM, nonvolatile memory, a hard disk drive, a solid state drive, a cloud storage, etc.) coupled to the accelerator 71 (a multicore CPU, a GPU, an FPGA, a systolic processing array, a compute-in-memory unit, etc.), storing a neural network code which, when executed by the accelerator 71, establishes an N-bit neural network 700 that has been trained using the bit-progressive training method (either including or not including use of multiple sets of batch normalization parameters), where M is a positive integer, and N is a positive integer greater than or equal to M. In practice, the computerized neural network system 7 may be realized by a computerized device (e.g., a smartphone, a tablet computer, a notebook computer, a desktop computer, etc.), and the computer program product that includes the neural network code may be stored in a server computer of a software vendor and to be downloaded by the computerized device so the computerized device that has downloaded the neural network code can execute the neural network code to establish the neural network 700 independently, but this disclosure is not limited in this respect. In one embodiment, the M-bit neural network accelerator 71 may be disposed within a mobile device, the storage module 70 that stores neural network code may be within a server computer that is remotely coupled to the mobile device through a communication network (so the M-bit neural network accelerator 71 is remotely coupled to the storage module 70 through the communication network), and the M-bit neural network accelerator 71 may execute the N-bit neural network 700 on the server computer through the communication network. The N-bit neural network 700 is switchable among different bitwidth modes that respectively correspond to different bitwidths, and has multiple sets of batch normalization parameters that respectively correspond to the different bitwidths to which the bitwidth modes correspond. In a case where M=N, the neural network accelerator 71 causes the neural network 700 to operate in one of the bitwidth modes that corresponds to a bitwidth of N (N-bit mode), and executes the neural network 700 that operates in the N-bit mode by using the set of the batch normalization parameters that corresponds to the bitwidth of the neural network accelerator 71, which is N. In a case where M<N, the neural network accelerator 71 causes the neural network 700 to operate in one of the bitwidth modes that corresponds to a bitwidth of M (M-bit mode) by narrowing, for each of the weights of the neural network 700, the weight from N bits to M bit(s) (however, in practice, it is possible that only some of the weights are narrowed from N bits to M bit(s) although this may be less effective), where the M bit(s) is/are related to the most significant M bit(s) of the weight, and to execute the neural network 700 that operates in the M-bit mode using the set of the batch normalization parameters that corresponds to the bitwidth of the neural network accelerator 71, which is M. For each of the weights, the number of bits may be narrowed down from N bits to M bits by rounding the N bits to the most significant M bits of the weight. A simplest way is to directly truncate the least significant (N-M) bit(s) of the weight, which also fits the bit-progressive training method, but this disclosure is not limited in this respect.

In this embodiment, the neural network 700 is exemplified as a 3-bit CNN that is switchable among three different bitwidth modes (referring to as 1-, 2- and 3-bit modes hereinafter, which respectively correspond to neural network accelerators of bitwidths of 1, 2 and 3), and three sets of batch normalization parameters BN1, BN2 and BN3 that respectively correspond to the bitwidths of 1, 2 and 3 are stored in the storage module 70.

In a case that the neural network accelerator 71 is a 3-bit CNN accelerator, the neural network accelerator 71 executes the neural network 700 that operates in the 3-bit mode which corresponds to the bitwidth of three by using the set of the batch normalization parameters BN3.

In a case that the neural network accelerator 71 is a 2-bit CNN accelerator, the neural network accelerator 71 may cause the neural network 700 to operate in the 2-bit mode by truncating, for each of the weights of the neural network 700, the least significant bit of the weight, and execute the neural network 700 that operates in the 2-bit mode using the set of the batch normalization parameters BN2.

Similarly, in a case that the neural network accelerator 71 is a 1-bit CNN accelerator, the neural network accelerator 71 may cause the neural network 700 to operate in the 1-bit mode by truncating, for each of the weights of the neural network 700, the least significant two bits of the weight, and execute the neural network 700 that operates in the 1-bit mode using the set of the batch normalization parameters BN1.

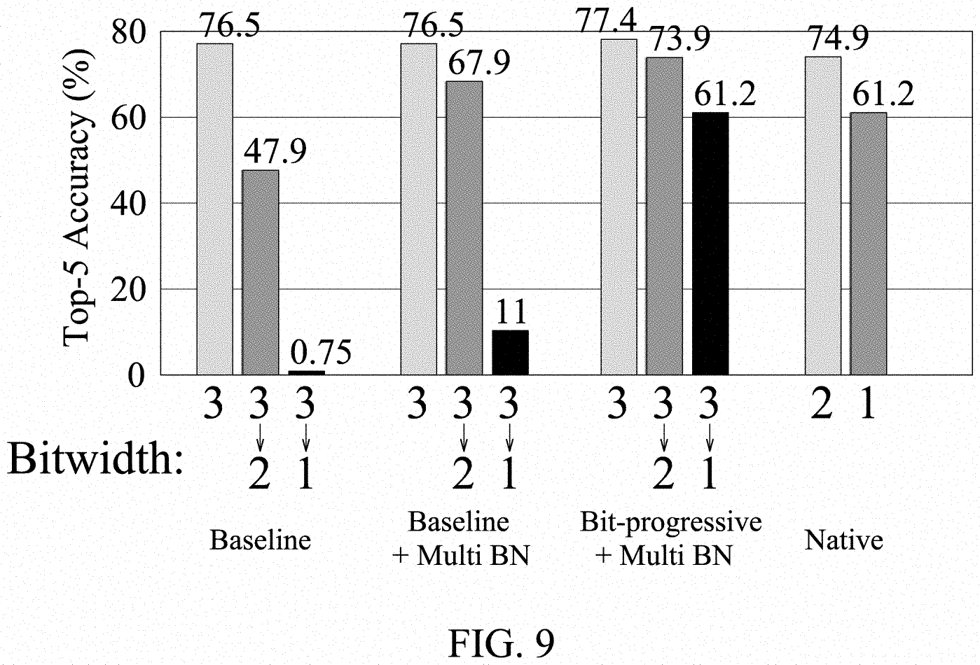

FIG. 9 shows experimental results that illustrate improvement achieved by this disclosure in terms of top-5 accuracy on ImageNet classification. The experiments were performed using a 3-bit AlexNet CNN, which was trained in three different manners. In the first manner (corresponding to “Baseline” in FIG. 9), the 3-bit CNN was trained using a conventional training method with the use of the bipolar number system, where for each of the weights of the 3-bit CNN, the three bits were trained together (as opposed to being trained separately), and only one set of batch normalization parameters was trained for 3-bit accelerators. In the second manner (corresponding to “Baseline+Multi BN” in FIG. 9), the 3-bit CNN was trained using the conventional training method with the use of the bipolar number system, and multiple sets of batch normalization parameters were trained for accelerators with different bitwidths. In the third manner (corresponding to “Bit-progressive+Multi BN” in FIG. 9), the 3-bit CNN was trained using the bit-progressive training method with the use of the bipolar number system, and multiple sets of batch normalization parameters were trained for accelerators with different bitwidths. The graph further shows experimental results of native 2-bit and 1-bit AlexNet CNNs respectively executed by 2-bit and 1-bit accelerators. When a 3-bit accelerator executed these trained CNNs, the top-5 accuracies of the trained CNNs were similar. When a 1-bit accelerator executed these trained CNNs in a manner that the least significant two bits were directly truncated for each weight, the top-5 accuracies of “Baseline” and “Baseline+Multi BN” respectively dropped to 0.75% and 11%, both of which are much lower than that when the 1-bit accelerator executed the native 1-bit AlexNet CNN and both of which are unacceptable. On the other hand, when the 1-bit accelerator executed the CNN trained in the third manner, the top-5 accuracy only dropped to 61.2%, which is the same as that when the 1-bit accelerator executed the native 1-bit AlexNet CNN. In addition, it can be seen from a comparison between “Baseline” and “Baseline+Multi BN” that the use of multiple sets of batch normalization parameters can effectively enhance accuracies when the CNN trained using the conventional training method was executed with a smaller bitwidth. It should be noted that this and the following disclosures are not limited to the aforementioned ImageNet classification. For instance, the disclosures can apply to prediction, object detection, generative adversarial networks, image processing, etc.

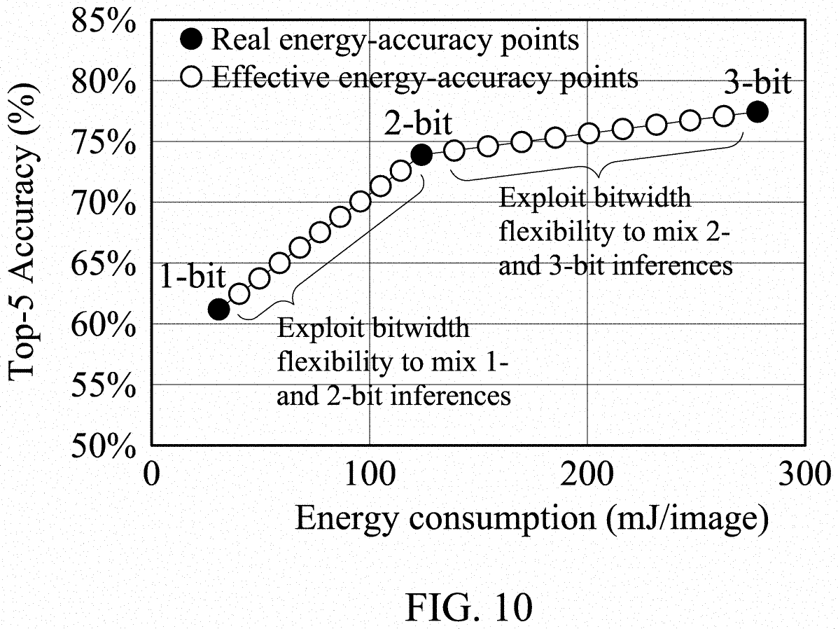

In practice, the accelerator may execute the neural network that is trained according to this disclosure in a manner of causing the neural network to operate among different bitwidth modes based on a condition (e.g., an accuracy requirement, an energy consumption budget, a battery level, and/or a temperature level of the computerized neural network system) of the CNN. FIG. 10 shows an energy-accuracy tradeoff line achieved by a neural network trained according to this disclosure (bit-progressive training+multiple sets of batch normalization parameters+bipolar number system). The solid circles denote the real 1-, 2-, and 3-bit modes, and the empty circles denote energy-accuracy points achieved by modulating bitwidths of the accelerator and the neural network. As shown in the figure, higher accuracy is achievable at the cost of higher energy. If the accuracy required of a computerized device (e.g., a smartphone) is 67%, which is higher than the accuracy of the 1-bit mode (61%) but lower than that of the 2-bit mode (73%), the computerized device can save energy by using the 1-bit mode to process half of the images and 2-bit mode to process the other half of the images ((61%+73%)/2=67%). With the bitwidth flexibility provided by this disclosure, the computerized device gains one more dimension (i.e., bitwidth in addition to voltage and frequency) to address the ever-increasing power- and thermal-management issues, which are especially concerned by portable devices such as smartphones, tablet computers, notebook computers, etc. Similarly, if the energy consumption budget of a computerized device is 200 mJ/image, which is higher than the energy consumption of the 2-bit mode but lower than that of the 3-bit mode, the computerized device can achieve the highest accuracy by using the 2-bit mode to process half of the images and using the 3-bit mode to process the other half of the images.

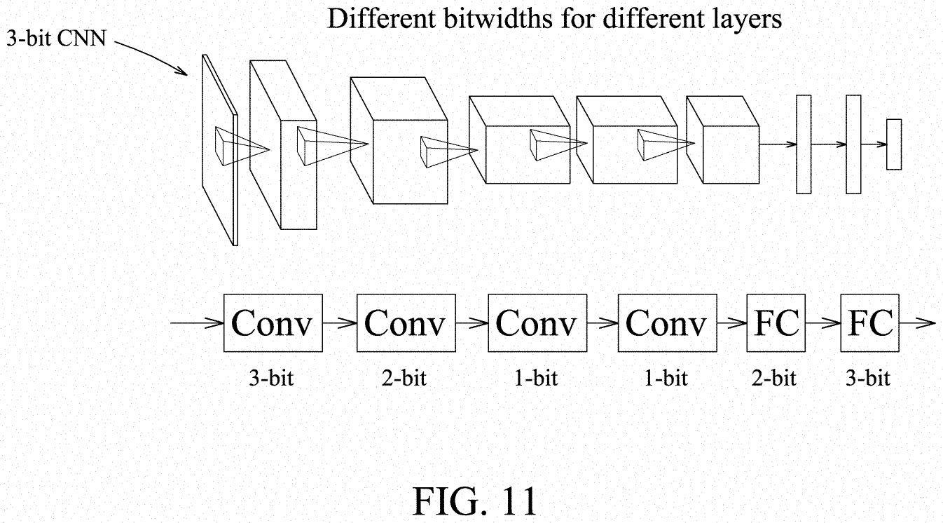

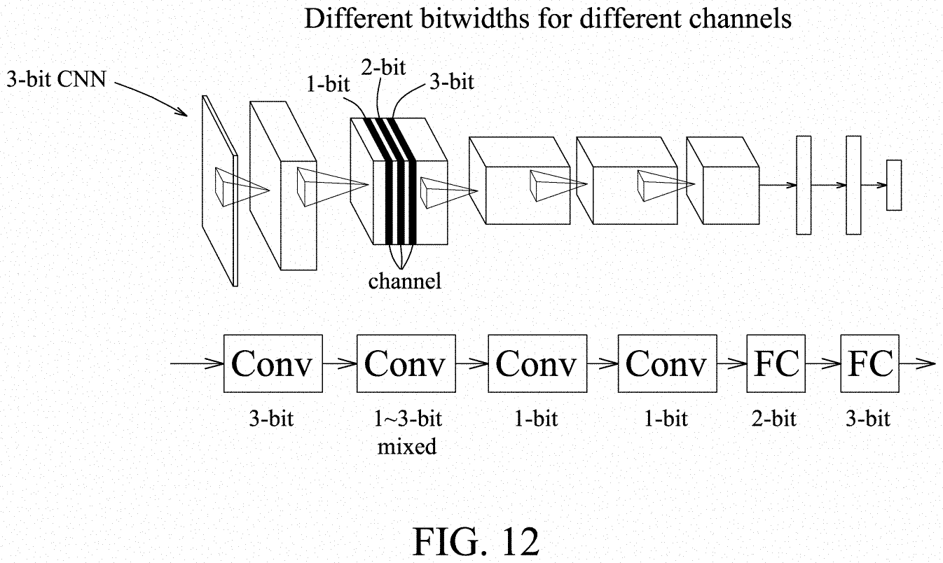

In one implementation, the accelerator may execute the neural network by, for each of the weights, using a part of the corresponding number of bits to perform computation, such that a total number of bits of said weights that are used in the computation is smaller than a number of bits of the weights in total. For instance, the neural network accelerator may execute the neural network by narrowing the bitwidth of (at least) one of the layers of the neural network, and/or execute the neural network by narrowing the bitwidth of (at least) one of the channel(s) of (at least) one of the layers. In one example where the neural network is a 3-bit CNN (i.e., each of the weights thereof is composed of three bits), the accelerator may execute the 3-bit CNN (i.e., each of the weights thereof is composed of three bits) by using all three bits for some of the weights, using two of the three bits (e.g., the most significant two of the three bits) for some of the weights, and using one of the three bits (e.g., the most significant bit among the three bits) for some of the weights, achieving complexity-accuracy flexibility. FIG. 11 exemplarily shows that computations for different layers of a 3-bit CNN may use different bitwidths (narrowing the bitwidths of some layers to 1 bit or 2 bits). FIG. 12 exemplarily shows that computations for different channels in the same layer may use different bitwidths (narrowing the bitwidths of some channels to 1 bit or 2 bits).

In summary, this disclosure uses the bit-progressive training method, multiple sets of batch normalization parameters and the bipolar number system to make a neural network have acceptable accuracies with a reduced bitwidth at inference time. The bitwidth flexibility thus achieved provides one more dimension to address power- and thermal-management issues.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of training an N-bit neural network, where N is a positive integer and N≥2, said method comprising:
providing the N-bit neural network that includes a plurality of weights to be trained, each of the weights being composed of N bits that respectively correspond to N bit orders which are divided into multiple bit order groups, wherein the bits of the weights are divided, based on the bit orders to which the bits of the weights correspond, into multiple bit groups that respectively correspond to the bit order groups; and
determining the weights for the N-bit neural network by training the bit groups one by one.

2. The method of claim 1, wherein the training the bit groups one by one includes: for each of the bit groups, training the bit group under the condition that, of each of the bit group (s) that has (have) been trained through a previous training, each of the bits is fixed at a corresponding value that was determined for the bit through the previous training.

3. The method of claim 2, wherein each of the bit groups has a representative bit order which is a highest one of the bit order(s) in the corresponding one of the bit order groups;
wherein the order of succession of training the bit groups is arranged from a most significant one of the bit groups to a least significant one of the bit groups;
wherein the most significant one of the bit groups is one of the bit groups that has a highest one of representative bit orders among the bit groups, and the least significant one of the bit groups is one of the bit groups that has a lowest one of the representative bit orders among the bit groups.

4. The method of claim 3, wherein, for each of the bit order groups that has at least two bit orders, the at least two bit orders are consecutive.

5. The method of claim 4, further comprising:
for the training of each of the bit groups, determining a set of batch normalization parameters dedicated to an entirety of the bit group and each of the bit group(s) that has been trained.

6. The method of claim 1, wherein one of the N bits that corresponds to a bit order of i represents 2ⁱ in decimal when having a first bit value, and represents −2ⁱ in decimal when having a second bit value, where i is an integer, and (N−1)≥i≥0.

7. The method of claim 1, further comprising:
for the training of each of the bit groups, determining a set of batch normalization parameters dedicated to an entirety of the bit group and each of the bit group(s) that has been trained before the bit group is being trained.

8. A computer program product comprising a neural network code that is stored on a computer readable storage medium, and that, when executed by a neural network accelerator, establishes a neural network having a plurality of sets of batch normalization parameters and a plurality of weights, said neural network being switchable among a plurality of bitwidth modes that respectively correspond to different bitwidths, wherein the sets of the batch normalization parameters respectively correspond to the different bitwidths, and wherein in each of the bitwidth modes, each of the weights has one of the bitwidths that corresponds to the bitwidth mode;
wherein, when executed by the neural network accelerator, said neural network operates in one of the bitwidth modes that corresponds to a bitwidth of the neural network accelerator, and one of the sets of the batch normalization parameters that corresponds to the bitwidth of the neural network accelerator is used by the neural network accelerator.

9. The computer program product of claim 8, wherein said neural network is an N-bit neural network, where N is a positive integer, and each of the weights of said neural network is composed of N bits;
wherein, for each of the bitwidth modes, the corresponding one of the different bitwidths is smaller than or equal to N;
wherein the neural network accelerator is an M-bit neural network accelerator of which the bitwidth is M, where M is a positive integer that is equal to one of the different bitwidths that respectively correspond to the bitwidth modes, and M<N; and
wherein, the neural network is caused by the neural network accelerator to operate in said one of the bitwidth modes that corresponds to a bitwidth of M by narrowing, for some of the plurality of weights of the neural network, the weights from N bits to M bit(s), where for each of the some of the plurality of weights, the M bit(s) is (are) related to the most significant M bit(s) of the weight, and the neural network is executed by the neural network accelerator using one of the sets of the batch normalization parameters that corresponds to the bitwidth of M.

10. The computer program product of claim 9, wherein the weight is narrowed from the N bits to the M bit(s) by directly truncating the least significant (N−M) bit(s) of the weight.

11. The computer program product of claim 9, wherein one of the N bits that corresponds to a bit order of i represents 2ⁱ in decimal when having a first bit value, and represents −2ⁱ in decimal when having a second bit value, where i is an integer, and (N−1)≥i≥0.

12. A computerized neural network system, comprising:
a storage module storing the computer program product of claim 8, and
a neural network accelerator coupled to said storage module, and configured to execute the neural network code of the computer program product.

13. The computerized neural network system of claim 12, further comprising a server computer and a device remotely coupled to said server computer through a communication network, wherein said storage module is within said server computer, and said neural network accelerator is within said device and is remotely coupled to said storage module through the communication network.

14. A computerized system comprising a plurality of multipliers, and a plurality of adders coupled to said multipliers, said multipliers and said adders to cooperatively perform computation, wherein, for some data pieces each including multiple bits that respectively correspond to multiple bit orders and each being used in the computation of some of the multipliers, one of the bits that corresponds to the bit order of i represents 2ⁱ in decimal when having a first bit value, and represents −2ⁱ in decimal when having a second bit value, where N is a number of bits of the data piece, i is an integer, and (N−1)≥i≥0.

15. A computerized neural network system, comprising:
a storage module storing a neural network that has a plurality of weights each composed of a respective number of bits, said weights having a first number of bits in total; and
a neural network accelerator coupled to said storage module, and configured to execute the neural network by, for each of the weights, using a part of the respective number of bits to perform computation, such that a total number of bits of said weights that are used in the computation is smaller than the first number.

16. The computerized neural network system of claim 15, wherein said neural network includes a plurality of layers each having a part of the weights and having a respective bitwidth that is defined as a number of bits each of the weights of the layer has; and
wherein said neural network accelerator is configured to execute the neural network by narrowing the bitwidth of one of the layers.

17. The computerized neural network system of claim 15, wherein said neural network includes a plurality of layers each having at least one channel which has a part of the weights and has a respective bitwidth that is defined as a number of bits each of the weights of the at least one channel has;
wherein said neural network accelerator is configured to execute the neural network by narrowing the bitwidth of one of the at least one channel of one of the layers.

18. A computerized neural network system, comprising:
a storage module storing a neural network that has a plurality of weights, and that is switchable among a plurality of bitwidth modes respectively corresponding to different bitwidths, wherein in each of the bitwidth modes, each of the weights has one of the bitwidths that corresponds to the bitwidth mode; and
a neural network accelerator coupled to said storage module, and configured to cause, based on a condition of said computerized neural network system, said neural network to operate between at least two of the bitwidth modes, and to execute the neural network that operates between at least two of the bitwidth modes.

19. The computerized neural network system of claim 18, wherein, for each of the weights, when the weight has a bitwidth of N, the weight is composed of N bits, and one of the N bits that corresponds to a bit order of i represents 2ⁱ in decimal when having a first bit value, and represents −2ⁱ in decimal when having a second bit value, where N is a positive integer, i is an integer, and (N−1)≥i≥0.

20. The computerized neural network system of claim 18, wherein the condition is one of an accuracy requirement, an energy consumption budget, a battery level, and a temperature level of said computerized neural network system.
